(19) United States
(12) Patent Application Publication
(10) Pub. No.: US 2023/0300359 A1
(43) Pub. Date: Sep. 21, 2023

(54) METHOD AND APPARATUS FOR GENERATING AND PROCESSING MEDIA FILE

(71) Applicant: CANON KABUSHIKI KAISHA, Tokyo (JP)

(72) Inventor: TORU SUNEYA, Kanagawa (JP)

(21) Appl. No.: 18/180,684

(22) Filed: Mar. 8, 2023

(30) Foreign Application Priority Data
Mar. 17, 2022 (JP) 2022-042910

(51) Int. Cl. H04N 19/46; H04N 19/132; H04N 19/169; G06V 20/40; H04N 19/167

(52) U.S. Cl. CPC H04N 19/46; H04N 19/132; H04N 19/188; G06V 20/44; H04N 19/167

(57) ABSTRACT

A method for generating a media file includes acquiring image data, generating first information indicating a region of interest that is at least a part of spatial regions in the image data, generating second information indicating a plurality of different display regions each including the region of interest, generating third information associating the first information with the second information, and storing the first information, the second information, and the third information in meta data of the media file.

### BACKGROUND

### Field of the Disclosure

The present disclosure relates to a method and an apparatus for generating and processing a media file.

### Description of the Related Art

With the increase in the number of pixels of image sensors and the improvement in the performance of optical lenses, monitoring cameras capable of capturing video images with high resolution such as 4K have been commercially available in recent years. The progress of video image analysis techniques utilizing artificial intelligence (AI) makes it possible to detect an abnormal behavior of a person or vehicle appearing in a video image, and to record information indicating a region of the video image where the abnormal behavior is detected.

Further, it has become possible to set the region where the abnormal behavior is detected or a predetermined region in a predetermined video image as a region of interest (ROI), and make the image quality of the ROI higher than that of the other regions.

Meanwhile, video image data with high resolution such as 4K can be displayed on limited devices. Thus, only the ROI is clipped to generate low-resolution video image data. Japanese Patent Application Laid-Open No. 2007-36339 discusses a technique of clipping a part of a wide-angle image and delivering the clipped image to a display apparatus.

However, in clipping the ROI, a file physically different from a file of the original video image data is newly generated, which causes an increase in the total amount of data.

### SUMMARY

According to an aspect of the present disclosure, a method for generating a media file includes acquiring image data, generating first information indicating a region of interest that is at least a part of spatial regions in the image data, generating second information indicating a plurality of different display regions each including the region of interest, generating third information associating the first information with the second information, and storing the first information, the second information, and the third information in meta data of the media file.

According to another aspect of the present disclosure, a method for processing a media file includes acquiring the media file, analyzing meta data of the media file, identifying first information stored in the meta data, the first information indicating a region of interest that is at least a part of spatial regions in image data stored in the media file, identifying second information stored in the meta data, the second information indicating a plurality of different display regions each including the region of interest, and identifying third information stored in the meta data, the third information associating the first information with the second information.

Further features of the present disclosure will become apparent from the following description of exemplary embodiments with reference to the attached drawings.

### BRIEF DESCRIPTION OF THE DRAWINGS

FIG. 1 is a block diagram illustrating a functional configuration of a media file generation apparatus according to an exemplary embodiment.

FIG. 2 is a diagram illustrating a state where a media file to which information indicating a region of interest (ROI) and display regions is added is displayed by the media file generation apparatus according to an exemplary embodiment.

FIG. 3 is a schematic diagram illustrating a structure of the media file to which the information indicating the region of interest and the display regions is added by the media file generation apparatus according to a first exemplary embodiment.

FIG. 4 is a diagram illustrating relations between items and properties stored in a High Efficiency Image File Format (HEIF) file according to the first exemplary embodiment.

FIG. 5 is a schematic diagram illustrating relations between the region of interest and image items in the media file generation apparatus according to the first exemplary embodiment.

FIG. 6 is a schematic diagram illustrating RegionItem extended by the media file generation apparatus according to the first exemplary embodiment.

FIG. 7 is a schematic diagram illustrating a relation between the region of interest and the image items in the media file generation apparatus according to a second exemplary embodiment.

FIGS. 8A and 8B are schematic diagrams illustrating a mechanism for grouping the image items in the media file generation apparatus according to the second exemplary embodiment.

FIG. 9 is a schematic diagram illustrating a configuration for setting the display regions as region items in the media file generation apparatus according to a third exemplary embodiment.

FIG. 10 is a schematic diagram illustrating a configuration for setting some regions in a moving image as a composite track in the media file generation apparatus according to a fourth exemplary embodiment.

FIG. 11 is a schematic diagram illustrating a configuration for setting some regions in the moving image as an extractor track in the media file generation apparatus according to the fourth exemplary embodiment.

FIG. 12 is a flowchart illustrating processing for generating the media file to which the information about the region of interest and the display regions is added, which is performed by the media file generation apparatus according to an exemplary embodiment.

FIG. 13 is a flowchart illustrating processing for playing back the media file to which the information about the region of interest and the display regions is added, which is performed by a media file processing apparatus according to an exemplary embodiment.

FIG. 14 is a block diagram illustrating a hardware configuration of an information processing apparatus to be used as the media file generation apparatus or the media file processing apparatus according to an exemplary embodiment.

### DESCRIPTION OF THE EMBODIMENTS

Exemplary embodiments of the present disclosure will be described in detail below with reference to the accompanying drawings. Configurations described in the following exemplary embodiments are merely examples and do not limit the present disclosure according to the appended claims. While a plurality of features is described in the exemplary embodiments, not all of the plurality of features is indispensable to the present disclosure, and the plurality of features can be optionally combined. In the accompanying drawings, identical or similar components are assigned the same reference numerals, and duplicated descriptions thereof will be omitted.

First, a functional configuration of a media file generation apparatus according to a first exemplary embodiment of the present disclosure will be described.

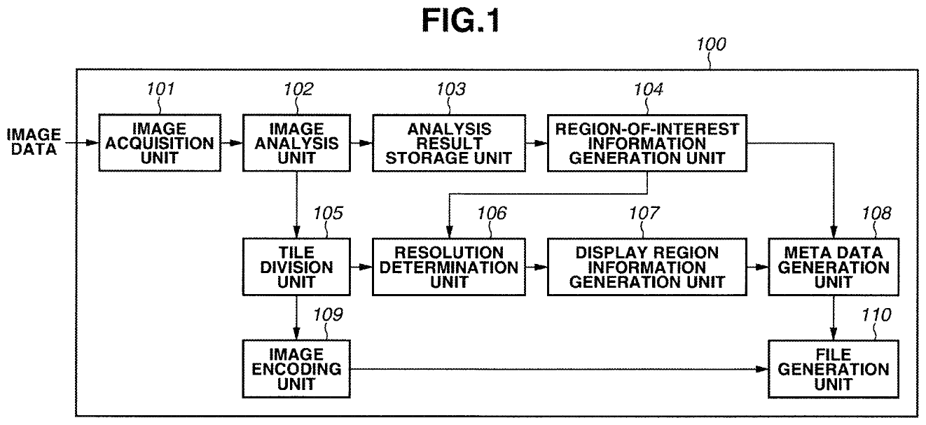

FIG. 1 is a block diagram illustrating a functional configuration of a media file generation apparatus 100 according to an exemplary embodiment of the present disclosure.

An image acquisition unit 101 acquires image data from an image capturing unit or via a network interface.

An image analysis unit 102 has a function of analyzing, for a person or object captured in the acquired image data, whether a predetermined event occurs.

An analysis result storage unit 103 stores therein a result of analyzing the image data by the image analysis unit 102. The analysis result includes information indicating a region of the image data where the predetermined event occurs, and information indicating details of the predetermined event. Examples of detection of the predetermined event include detection of entry of an object into a predetermined area or line set on the image, detection of an object left behind or carried away, and detection of a specific object, person, or face, but the present exemplary embodiment is not limited thereto.

A region-of-interest information generation unit 104 has a function of referring to the analysis result stored in the analysis result storage unit 103 to determine the region where the predetermined event occurs as a region of interest (ROI). The region-of-interest information generation unit 104 then generates information indicating the region of interest that is a part of spatial regions in the image data.

Meanwhile, after analyzing the image data, the image analysis unit 102 transfers the image data to a tile division unit 105. The tile division unit 105 has a function of dividing the image data into tiles each of which has a predetermined rectangular size. The image data divided into tiles is transferred to an image coding unit 109. The image coding unit 109 has a function of encoding the image data based on a predetermined coding format.

A resolution determination unit 106 acquires, from the tile division unit 105, rectangular size information about the image data divided into tiles and acquires, from the region-of-interest information generation unit 104, information indicating the coordinates and size of the region of interest. The resolution determination unit 106 has a function of determining at least one region size that is larger than that of the region of interest and has a resolution being an integral multiple of the rectangular size.

A display region information generation unit 107 has a function of determining, as a display region, a rectangular region including at least a part of the region of interest and being formed along the boundary lines of the tiles of the image data, based on the coordinates of a region having the resolution determined by the resolution determination unit 106. The display region information generation unit 107 then generates information indicating a plurality of different display regions each including the region of interest.

A meta data generation unit 108 has a function of generating meta data including the information indicating the region of interest generated by the region-of-interest information generation unit 104 and the information indicating the display regions generated by the display region information generation unit 107, and including information associating these pieces of information with each other.

A file generation unit 110 has a function of generating a media file storing the generated meta data and the image data encoded by the image coding unit 109.

Next, an exemplary embodiment using a mechanism for storing annotation information in a High Efficiency Image File Format (HEIF) file currently being studied by International Organization for Standardization (ISO)/International Electrotechnical Commission (IEC) 23008-12:2017 DAM2 will be described.

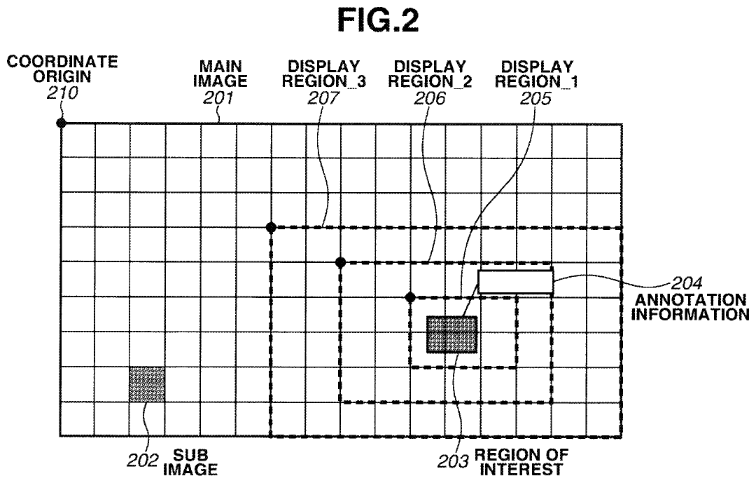

FIG. 2 illustrates a state where a media file to which the information indicating the region of interest and the display regions is added is displayed by the media file generation apparatus 100 according to an exemplary embodiment of the present disclosure.

Referring to FIG. 2, a main image 201 is configured to complete one image by displaying a plurality of sub images 202 in a tiled manner. In the example of FIG. 2, 16 sub images 202 are arranged in the horizontal direction, and nine sub images 202 are arranged in the vertical direction. In other words, the main image 201 includes a total of 144 sub images 202.

An image having such a configuration is referred to as a grid image. If a region of interest 203 is set in the main image 201 and annotation information 204 associated with the region of interest 203 is included in the main image 201, the annotation information 204 can be displayed as illustrated in FIG. 2. For example, the result of image data analysis (described below), such as a detected anomaly type, a detected event type, and a detected specific object type, can be displayed as the annotation information 204.

Further, three display regions 205 to 207 are set to surround the region of interest 203. More specifically, the display region_1 205 includes six sub images 202. Likewise, the display region_2 206 includes 24 sub images 202, and the display region_3 207 includes 60 sub images 202. In this way, each of the display regions 205 to 207 includes the region of interest 203 and is set along the boundary lines of the sub images 202.

A structure of a media file including a still image to which information about such regions is added will be described next.

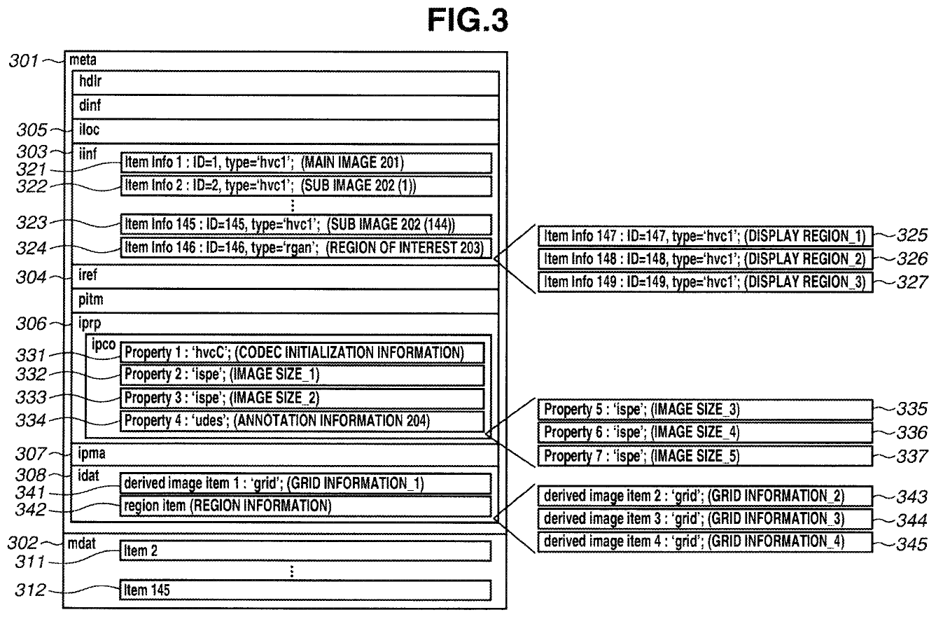

FIG. 3 is a schematic diagram illustrating the structure of the media file to which the information indicating the region of interest 203 and the display regions 205 to 207 is added by the media file generation apparatus 100 according to the first exemplary embodiment.

Referring to FIG. 3, the media file conforms to a standard related to the HEIF file currently being standardized by ISO/IEC 23008-12. A still image stored in the HEIF file is called an item. The HEIF file includes meta 301 that stores meta data indicating coding information about each item and the coded data storage location of each item, and mdat 302 that stores the data of each item.

Referring to FIG. 3, each rectangular region to which four alphabetical characters are added is a logical region called a box. ISO base media file format (hereinafter referred to as ISOBMFF) as basic specifications referred to by HEIF and ISOBMFF-based derived file formats are combined using nested boxes.

The role of each box will be described focusing on information mainly related to the present exemplary embodiment. The meta 301 includes boxes such as iinf (item information) 303, iref (item reference) 304, iloc (item location) 305, iprp (item properties) 306, ipma (item property association) 307, and idat (item data) 308. The iinf 303 stores information indicating the identifier for identifying a stored item and the type of the item. The item includes data other than the still image. For example, Exif data generated when the still image is captured by a digital camera, and region information indicating some regions in the still image can also be stored as the item.

The iinf 303 in FIG. 3 stores, as Item info_1 321, item information about the main image 201 in FIG. 2. The Item info_1 321 has an item ID of 1 and an item type ‘hvc1’ that indicates that the main image 201 is High Efficiency Video Codec (HEVC) coded data. Likewise, for the sub images 202, 144 pieces of item information from Item info_2 322 to Item info_145 323 are stored. The Item info_2 322 to the Item info_145 323 have item IDs of 2 to 145, respectively, and have the item type ‘hvc1’ like the main image 201. Further, for the region of interest 203, item information is stored as Item info_146 324. The Item info_146 324 has an item ID of 146 and an item type ‘rgan’ that indicates region information.

Instead of storing the item data in the mdat 302, the item data can be stored in the idat 308 in the meta 301. In the example of FIG. 3, 144 items from Item_2 311 to Item_145 312 stored in the mdat 302 are the sub images 202 described above with reference to FIG. 2. Out of two items stored in the idat 308, i.e., a derived image item_1 341 and a region item 342, the derived image item_1 341 indicates the main image 201, and the region item 342 indicates the region of interest 203.

The derived image item_1 341 stores information indicating that the sub images 202 are tiled and does not include the coded data of the still image. The region item 342 is meta data indicating coordinate information and does not include large-sized data such as coded data. Such data is desirably stored as follows. If an item is large-sized coded data such as a still image, the data is stored in the mdat 302. If an item is relatively small-sized data such as meta data, the data is stored in the idat 308.

The iref 304 is a box for storing association information between items. This box stores, for example, association information between a still image and Exif data or association information between a still image and region information, and defines a reference type corresponding to the association relation between items. For example, cdsc (content describes) is defined as the type of association between items related to region information. The cdsc intends to add explanatory information to the reference destination item.

The iloc 305 is a box for storing information indicating the position of each item stored in the HEIF file. This box defines a construction method as information indicating the storage location of each item. For example, if the iref 304 defines the cdsc as the reference type, the construction method “1” is generally defined. The construction method “1” indicates that the item storage location is the idat 308. In this case, the item related to the region information is stored in the idat 308. In the example of FIG. 3, the region item 342 is the item for storing the region information.

The derived image item_1 341 has dimg as the reference type. As described above, since this item does not include large-sized coded data, the construction method “1” is also often defined in this case.

The iprp 306 stores item properties. Examples of the stored properties include coding parameters of items and image size information. In the example of FIG. 3, four different properties, i.e., Property_1 331, Property_2 332, Property_3 333, and Property_4 334 are stored in the iprp 306. The Property_1 331 indicates codec initialization information about coded data. The Property_2 332 and the Property_3 333 each indicate image size information. The Property_4 334 indicates annotation information related to a partial image region. The Property_4 334 corresponds to the annotation information 204 in FIG. 2.

Information associating these properties with items is stored in the ipma 307. The Property_1 331 and the Property_2 332 are associated with the derived image item_1 341. The Property_1 331 and the Property_3 333 are associated with 144 items from the Item_2 311 to the Item_145 312. The Property_4 334 is associated with the region item 342. In other words, the codec initialization information and the corresponding image size information are associated with still image items, and the annotation information is associated with a region information item.

How the data related to the main image 201, the 144 sub images 202, the region of interest 203, and the annotation information 204 in FIG. 2 is stored has been described above with reference to FIG. 3. Three display regions in FIG. 2, i.e., the display region_1 205, the display region_2 206, and the display region_3 207 will be subsequently described with reference to FIG. 3.

A first method for adding information indicating the display regions 205 to 207 is to define these display regions as grid images including the plurality of sub images 202, similarly to the main image 201. More specifically, boxes illustrated on the right side of FIG. 3 are added in order to define the meta data of the HEIF file with the display region_1 205 to the display region_3 207 in FIG. 2 as grid images.

Item info_147 325, Item info_148 326, and Item info_149 327 in FIG. 3 are boxes for storing item information when the display region_1 205 to the display region_3 207 are defined as image items. Property_5 335, Property_6 336, and Property_7 337 store information indicating the image sizes of the display region_1 205 to the display region_3 207, respectively. Information indicating the sub images 202 included in the display region_1 205 to the display region_3 207 is stored in derived image item_2 343, derived image item_3 344, and derived image item_4 345, respectively.

In such a manner, three display regions (the display region_1 205 to the display region_3 207) each including the region of interest 203, which are parts of the main image 201, are defined as still image items in the HEIF file. Thus, even if a device for displaying an image including the region of interest 203 in FIG. 2 is unable to display the main image 201 with excessively high resolution, the device can perform display processing. More specifically, the device can select a region having a suitable resolution from among the set three display regions 205 to 207, acquire only the sub images 202 included in the selected region, and perform display processing. Applicable resolutions include Video Graphics Array (VGA), Super VGA (SVGA), eXtended Graphics Array (XGA), Wide XGA (WXGA), Full High Definition (Full-HD), Wide Ultra XGA (WUXGA), 4K, and 8K.

While in the example of FIG. 2, even the display region_1 205, which is the smallest of the three display regions 205 to 207, includes the entire region of interest 203, this is not essential. Each of the display regions 205 to 207 may not necessarily include the entire region of interest 203. In other words, each of the display regions 205 to 207 includes at least a part of the region of interest 203. For example, if the region of interest 203 is a thin region or divided into a plurality of regions, the region of interest 203 can be divided by any of the display regions 205 to 207.

While FIG. 2 indicates that the region of interest 203 is arranged at the center in setting a display region, this is merely an example. For example, if persons or objects associated with an event occurring in the region of interest 203 are in the periphery, a display region may be set to include as many of the persons or objects as possible.

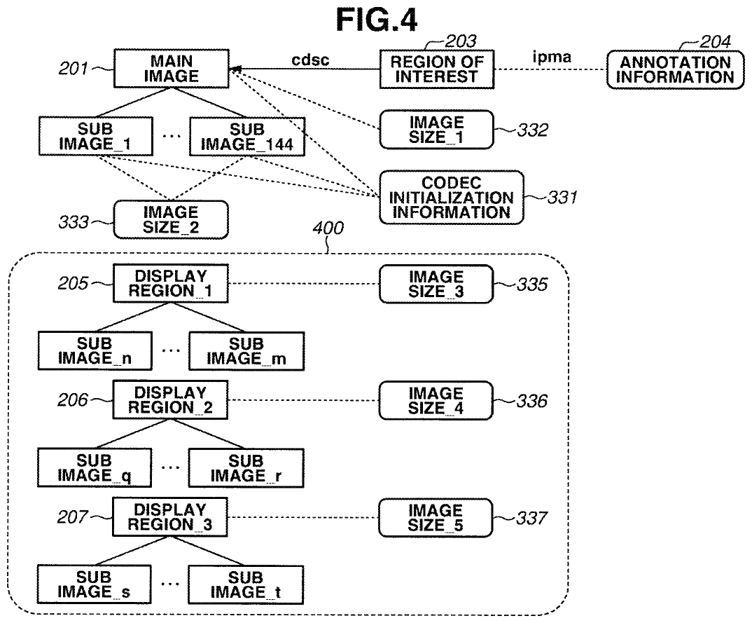

Relations between the items and the properties stored in the HEIF file will be described next with reference to FIG. 4.

FIG. 4 illustrates the relations between the items and the properties stored in the HEIF file having the configuration information described above with reference to FIG. 3. Referring to FIG. 4, the main image 201 is a grid image including the 144 sub images 202 and is associated with two properties, i.e., the Property_2 (the image size_1) 332 and the Property_1 (the codec initialization information) 331. Each of the sub images 202 is associated with the Property_3 (the image size_2) 333 as an individual rectangular size, and the codec initialization information 331.

The configuration of the display region_1 205 to the display region_3 207 is illustrated as a region 400 surrounded by a dotted line in FIG. 4. The display region_1 205 is a grid image including six sub image_n to sub image_m and is associated with the Property_5 (the image size_3) 335. As illustrated in FIG. 2, the six sub images associated with the display region_1 205 are some of the 144 sub images 202. The codec initialization information 331 and the image size of the sub images are thus the same as the main image 201 and the 144 sub images 202 and are omitted in FIG. 4. The display region_2 206 and the display region_3 207 are configured in a similar way to the display region_1 205.

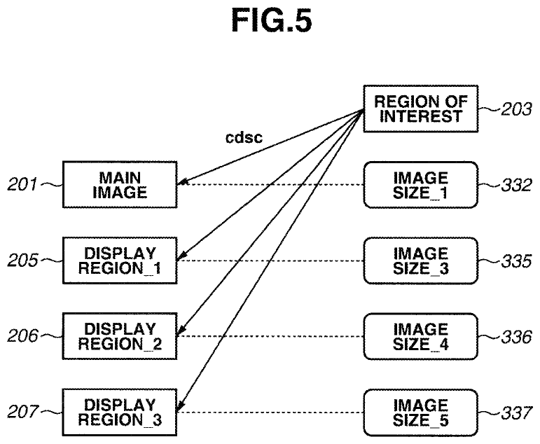

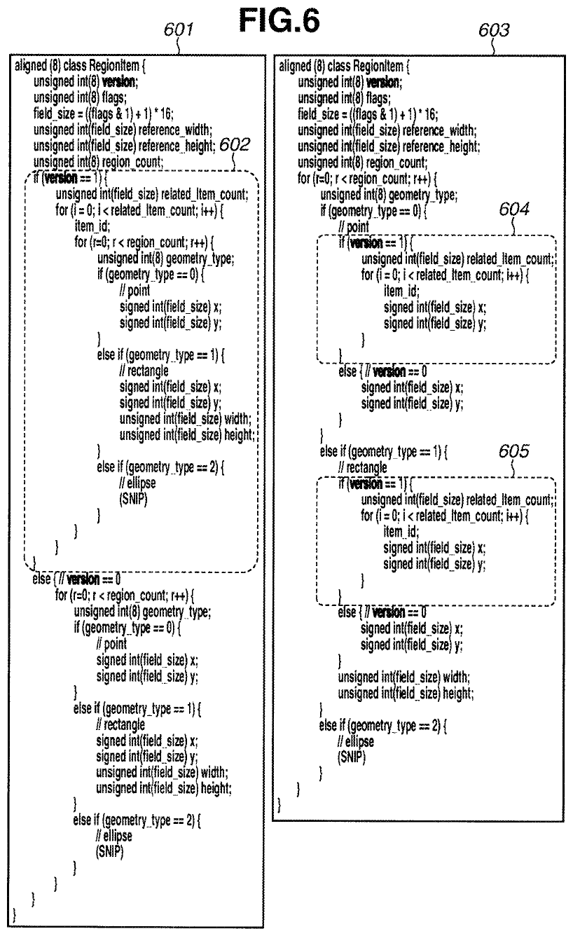

The configuration of the region of interest 203 will be described next with reference to FIGS. 5 and 6.

FIG. 5 is a schematic diagram illustrating the associations between the region of interest 203 and the image items in the media file generation apparatus 100 according to the present exemplary embodiment.

Referring to FIG. 5, the region of interest 203 is associated with the main image 201, the display region_1 205, the display region_2 206, and the display region_3 207. However, as illustrated in FIG. 2, these image items have different image sizes and different coordinate positions of their upper left corners.

In HEIF, a box called RegionItem is used to indicate spatial position information about an image region such as the region of interest 203. RegionItem defines the position of the region based on offset values from a coordinate origin 210 at the upper left corner of an image item associated therewith.

When describing spatial position information about the region of interest 203 with respect to different display regions (the display region_1 205 to the display region_3 207) as illustrated in FIG. 2, the display region_1 205 to the display region_3 207 have different coordinate origins 210 (different coordinates of their upper left corners). Thus, the spatial position information about the region of interest 203 with respect to the display region_1 205 to the display region_3 207 is to be defined based on respective different offset values.

However, RegionItem with the conventional specifications can define only one piece of offset information. Thus, when defining spatial position information by associating a certain region with a plurality of other regions, it is necessary to define offset information using a different RegionItem box for each of the plurality of other regions. More specifically, when defining the spatial position information about the region of interest 203 with respect to the main image 201, the display region_1 205, the display region_2 206, and the display region_3 207, it is necessary to define four different pieces of offset information using four different RegionItem boxes, which is not efficient. In addition, it is hard to understand that the regions of interest associated with the respective image items (the main image 201, and the display region_1 205 to the display region_3 207) are actually the same region (the region of interest 203).

The present exemplary embodiment, therefore, introduces a mechanism for using one RegionItem to define offset information about the associated plurality of image items even if the image items have different coordinate origins 210.

FIG. 6 is a schematic diagram illustrating RegionItem extended by the media file generation apparatus 100 according to the present exemplary embodiment.

FIG. 6 illustrates two examples (descriptions 601 and 603) as methods for extending RegionItem. Both of the examples are illustrated so that the extension of conventional RegionItem is enabled when the version of the box is “1”.

As illustrated in FIG. 6, RegionItem enables defining a plurality of regional shapes using one item. However, offset values “signed int(field_size) x” and “signed int(field_size) y” have one definition for each of the regional shapes.

The description 601 indicates an example of extending RegionItem so that the coordinate definition for each regional shape can be described for each of a plurality of items.

More specifically, in the description 602, “related_Item_count” indicates the number of image items associated with RegionItem, and “item_id” describes the item ID of each image item. Thus, the offset values and the size information for each region type (geometry type) can be described for each of the associated image items.

On the other hand, as indicated in descriptions 604 and 605, the description 603 extends RegionItem so that only the offset values for each region type can be described for each of the associated image items. Both of the above-described extension methods are applicable to a case where one RegionItem is associated with image items having different position coordinates of their upper left corners as illustrated in FIG. 5.

In both of the cases of the descriptions 601 and 603, the conventional specifications of RegionItem are applied when the version is “0”.

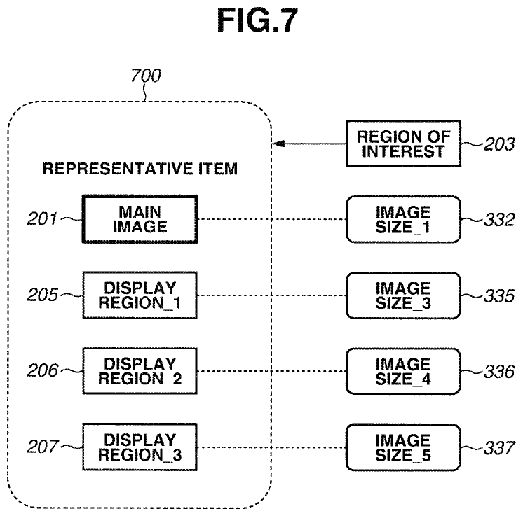

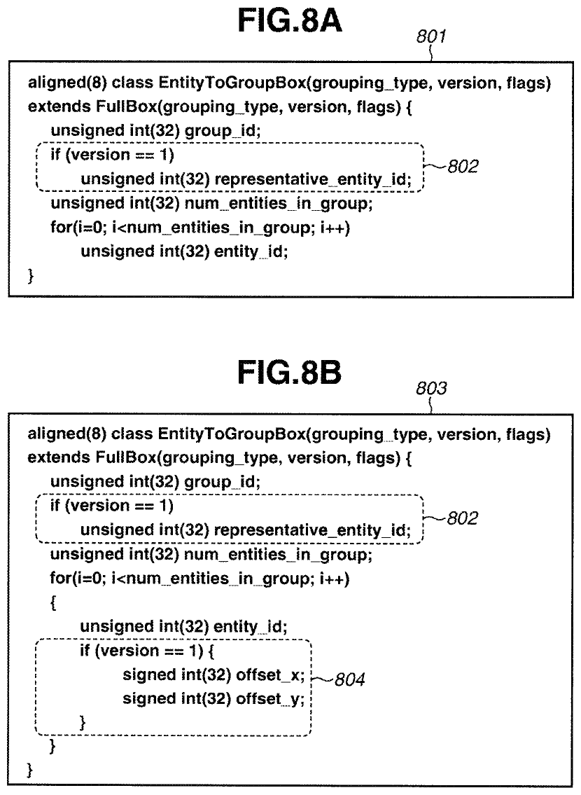

In a second exemplary embodiment, a method different from the method for optimizing the associations between RegionItem and the image items in FIG. 6 according to the first exemplary embodiment will be described with reference to FIGS. 7 and 8. The method according to the first exemplary embodiment associates the same region (the region of interest 203) with a plurality of regions (the main image 201 and the display region_1 205 to the display region_3 207) by extending the specifications of RegionItem. The second exemplary embodiment is different from the first exemplary embodiment in that the method implements the association by extending the specifications of EntityToGroupBox.

FIG. 7 is a schematic diagram illustrating a relation between the region of interest 203 and the image items in the media file generation apparatus 100 according to the present exemplary embodiment.

Referring to FIG. 7, a group 700 surrounded by a dotted line groups four image items (the main image 201, and the display region_1 205 to the display region_3 207). FIG. 7 also illustrates a state where one image item (the main image 201) in the group 700 is defined as a representative item. When RegionItem indicating the region of interest 203 is associated with the group (group information) 700, the coordinates of the upper left corner of the representative item are determined to be representative coordinates of the group 700.

A mechanism for grouping the image items and defining the representative item will be described with reference to FIGS. 8A and 8B. FIGS. 8A and 8B are schematic diagrams illustrating a mechanism for grouping the image items in the media file generation apparatus 100 according to the present exemplary embodiment.

Referring to FIG. 8A, a description 801 extends EntityToGroupBox that is a conventional mechanism for grouping image items, so that the item ID of the representative item of the group 700 can be described when the version is “1”. “representative_entity_id” in a description 802 indicates the item ID of the representative item. When the image items arranged in the same two-dimensional space as illustrated in FIG. 2 are grouped, the coordinate origin 210 of the representative item is set as the coordinate origin 210 of this group (the group 700).

When the representative item of the group 700 of the image items is the main image 201 as illustrated in FIG. 7, the offset values of RegionItem can be defined for the region of interest 203 associated with the group 700, using the upper left corner of the main image 201 as the coordinate origin 210.

It is possible to determine that the main image 201 and the display region_1 205 to the display region_3 207 are arranged in the same two-dimensional space and determine the relative coordinate relations between these image items since the image items include the same sub images 202. However, the arrangement and the relations are not clear before being determined through the analysis of the sub images 202 included in the image items. A description 803 in FIG. 8B is a further extended version of the description 801 in FIG. 8A. This extension is made not only to group these image items but also to clarify the relative positional relations.

Referring to the description 803 in FIG. 8B, a description of the positional relations between the image items is added to the description 801. More specifically, the positional relations are described based on the coordinates of the upper left corner of the image of the representative item in a description 804 surrounded by a dotted line. Using offset values to indicate the coordinate position of the upper left corner of each image item (each group member) enables clarifying the arrangement of the image items in the same two-dimensional space and the relative positional relations between the image items. When “entity_id” is identical to “representative_entity_id”, the offset values in the description 804 are both “0”. For EntityToGroupBox where image items having such relations are set as group members, a grouping type indicating the characteristics can be set. Example of the grouping type include ofst (offset), roal (region of alternative), and groi (group of ROI).

The items set as the group members of EntityToGroupBox in this way often have the same attribute information. Thus, if the attribute information about each item belonging to the group is not particularly associated, the attribute information about the representative item can be applied. For example, member items having the same codec initialization information as that of the representative item inherit the codec initialization information about the representative item if no codec initialization information is associated with the member items. In addition, the configurations of the descriptions 801 and 803 can include a flag indicating whether to inherit the attribute information about the representative item.

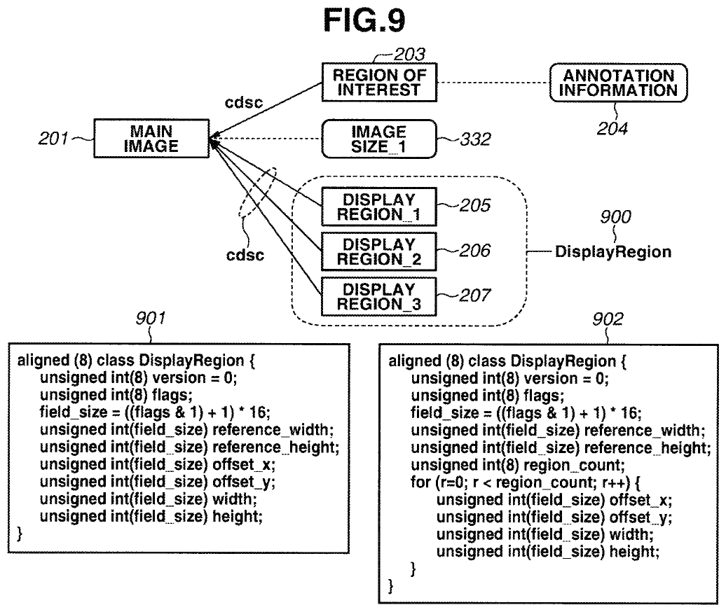

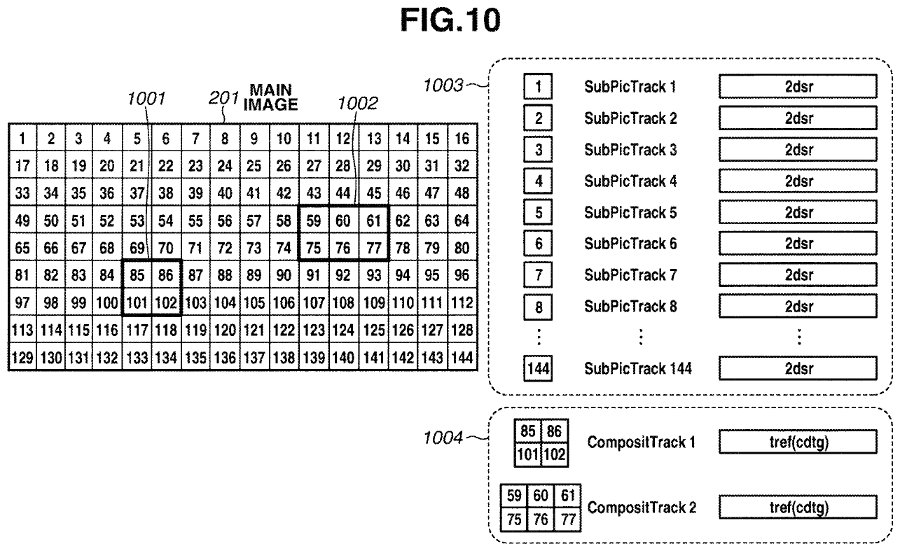

In the above-described exemplary embodiments, the display region_1 205 to the display region_3 207 are set as grid images including the sub images 202, i.e., image items. A configuration for setting the display regions 205 to 207 as items similar to RegionItem instead of image items will be described next with reference to FIGS. 9 and 10.

FIG. 9 is a schematic diagram illustrating a configuration for describing, as a region item, DisplayRegion representing a display candidate in the media file generation apparatus 100 according to a third exemplary embodiment.

Referring to FIG. 9, the main image 201 is an image item and is associated with the region of interest 203 which is RegionItem, and the region of interest 203 is associated with the annotation information 204 like the above-described exemplary embodiments.

According to the present exemplary embodiment, the display region_1 205 to the display region_3 207 are set as items indicating regions expected to be displayed. More specifically, DisplayRegion 900 in FIG. 9 is defined as an item having configuration information like a description 901 or 902.

The description 901 has a box configuration having similar parameters to the configuration of the rectangular type (geometry_type==1) of RegionItem. More specifically, the box is formed of a reference width and a reference height (reference_width, reference_height), offset values from the reference coordinates (offset_x, offset_y), and a width and a height (width, height) of the region. These pieces of information can be used to obtain positional information in proportion calculation when the sizes of the associated image items are different. This region is intended to be a candidate region in displaying an image item. More specifically, it is desirable that, when a file including the image item associated with this DisplayRegion item is displayed, a file parser should interpret this region as the candidate region to be displayed.

When the main image 201 includes the plurality of sub images 202, the region defined by the DisplayRegion item can be set along the boundary lines of the sub images 202 so as not to divide the sub images 202. This enables improving the processing efficiency in reading data for display and performing playback processing.

As illustrated in the description 902 in FIG. 9, a plurality of rectangular regions can be defined by one DisplayRegion item.

RegionItem can express regions of various shapes other than rectangles. When setting a non-rectangular region as a display region, it is also possible to add, to existing RegionItem, a flag indicating that the region is a display candidate. In addition, it is also possible to associate, with existing RegionItem, attribute information indicating that the region is a display candidate.

A fourth exemplary embodiment will be described next. The first exemplary embodiment assumes the file format of a still image, whereas the present exemplary embodiment assumes the file format of a moving image.

In the following descriptions, applied file formats of a moving image include Omnidirectional MediA Format (OMAF) standardized in ISO/IEC 23090-2, and network abstraction layer unit (NALU) file format (Carriage of NAL unit structured video in ISOBMFF) standardized in ISO/IEC 14496-15.

FIG. 10 is a schematic diagram illustrating a configuration for setting some regions in a moving image as a composite track in the media file generation apparatus 100 according to the present exemplary embodiment. Referring to FIG. 10, the main image 201 is a moving image divided into 144 sub images 202, and the respective sub images 202 are stored as 144 sub picture tracks as illustrated in a sub picture track group 1003.

Each of the sub picture tracks is defined as a track for storing sub picture data subjected to tile division in OMAF, and has a mechanism for storing configuration information about two-dimensional spatial coordinates when the track type is ‘2dsr’.

In the present exemplary embodiment, a composite track is defined as a track for combining pieces of moving image data stored in the sub picture tracks subjected to tile division. A composite track group 1004 in FIG. 10 includes two composite tracks.

These composite tracks correspond to a region_1001 and a region_1002 that are parts of the main image 201.

A composite track, which is a combination of sub pictures, is generated by referring to desired sub picture tracks as tracks having ‘cdtg’ as the reference type. Thus, configuring the display region_1 205 to the display region_3 207 in FIG. 2 using the composite tracks described with reference to FIG. 10 enables selectively playing back the regions set as the display regions 205 to 207.

The method illustrated in FIG. 10 hardly copes with a case where the region of interest 203 and the display regions 205 to 207 change from time to time. To address the case, a method for setting a region in units of moving image frames will be described next.

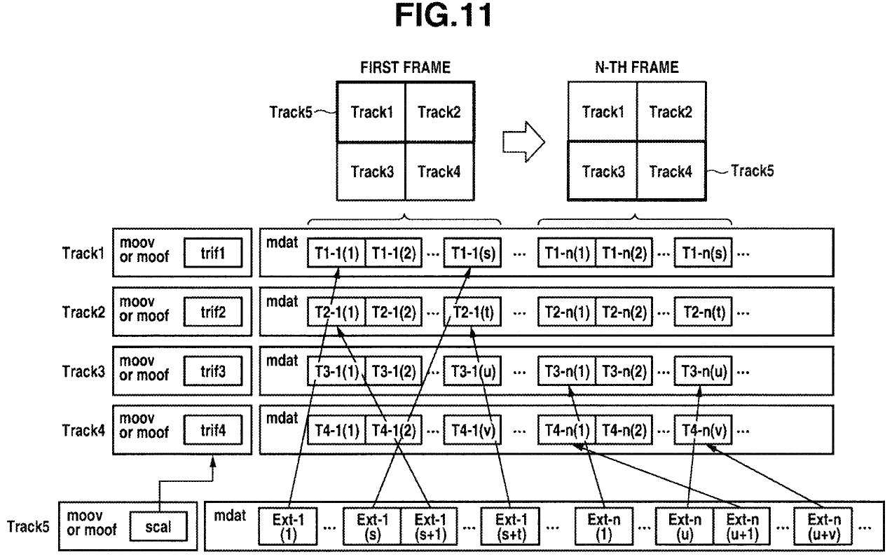

FIG. 11 is a schematic diagram illustrating a configuration for setting, as an extractor track, some regions in a moving image in the media file generation apparatus 100 according to the present exemplary embodiment.

FIG. 11 illustrates a state where the moving image is divided into four regions and these four regions are stored in different tracks (Track_1 to Track_4). Track_5 has a configuration for configuring a frame including any samples extracted from the tracks (Track_1 to Track_4). More specifically, Track_5 has a mechanism, called an extractor, for extracting samples from the other tracks. In the example of FIG. 11, for the first frame, the mechanism extracts samples from Track_1 and Track_2 to configure a frame including regions corresponding to a combination of Track_1 and Track_2. For the n-th frame, the mechanism can extract samples from Track_3 and Track_4 to configure a frame including regions corresponding to a combination of Track_3 and Track_4.

In other words, the mechanism stores the sub images 202 in FIG. 2 in different tracks, and, for each display region, extracts samples as an extractor track from tracks storing desired sub images, in units of frames. This enables setting any region data as a display region in units of frames.

In other words, even if the main image 201, the sub images 202, the region of interest 203, the display region_1 205 to the display region_3 207 illustrated in FIG. 2 are included in a moving image, the method illustrated in FIGS. 10 and 11 enables optionally setting the display region_1 205 to the display region_3 207 each including the region of interest 203.

The difference between the first and second exemplary embodiments is the difference between a still image and a moving image. This means that the playback processing according to the first exemplary embodiment is also applicable to a moving image.

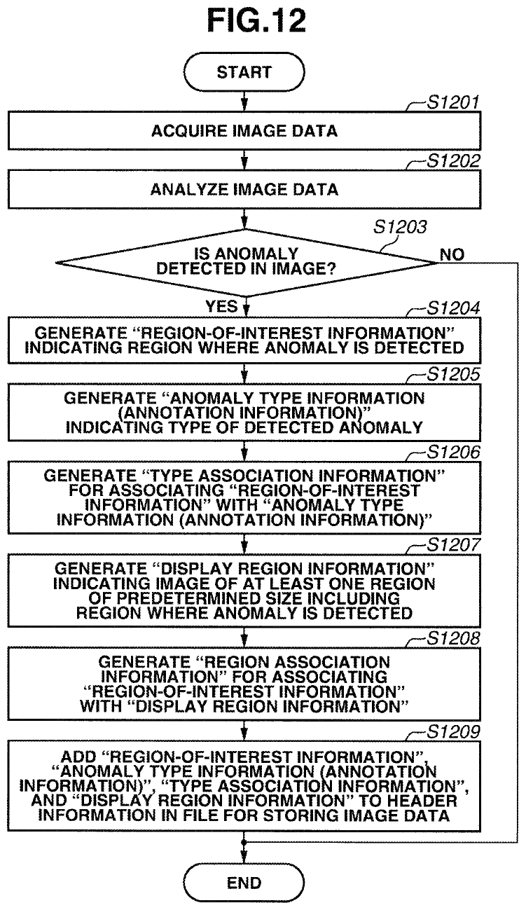

The above-described main image 201 is analyzed and, based on the analysis result, a part of the main image 201 is set as the region of interest 203. A series of processing up to the processing for setting regions including the region of interest 203 as the display region_1 205 to the display region_3 207 will now be described with reference to FIG. 12.

FIG. 12 is a flowchart illustrating processing performed by the media file generation apparatus 100 according to any of the first to fourth exemplary embodiments.

Referring to FIG. 12, in step S1201, image data is acquired.

In step S1202, the image data is analyzed. The image data can be analyzed using image processing algorithms. A wide range of monitoring cameras use software for detecting abnormal behaviors of persons or vehicles in the image.

In step S1203, whether an anomaly is detected in the image is determined. If an anomaly is detected in the image (YES in step S1203), the processing proceeds to step S1204. If no anomaly is detected in the image (NO in step S1203), the processing exits the flowchart.

In step S1204, “region-of-interest information” indicating the region where the anomaly is detected is generated. The “region-of-interest information” corresponds to the Item info_146 324 that is item information in the iinf 303 illustrated in FIG. 3.

In step S1205, “anomaly type information (annotation information)” indicating the type of the detected anomaly is generated. The “anomaly type information (annotation information)” corresponds to the Property_4 334 that is a property in the iprp 306 illustrated in FIG. 3.

In step S1206, “type association information” for associating the “region-of-interest information” with the “anomaly type information (annotation information)” is generated. The “type association information” corresponds to the ipma 307 illustrated in FIG. 3.

In step S1207, “display region information” indicating the image of at least one region of a predetermined size including the region (the region of interest 203) where the anomaly is detected is generated. The “display region information” corresponds to the Item info_147 325 to the Item info_149 327 that are item information in the iinf 303 illustrated in FIG. 3.

In step S1208, “region association information” for associating the “region-of-interest information” with the “display region information” is generated. The “region association information” corresponds to RegionItem and Track_5 (the extractor track) when RegionItem, EntityToGroupBox, and DisplayRegion are applied.

In step S1209, the “region-of-interest information”, the “anomaly type information (annotation information)”, the “type association information”, and the “display region information” are added to header information in the file for storing the image data.

The processing performed when an anomaly is detected has been described above. The processing can also be performed in the case of detecting an event or a specific object. The image data analysis may not necessarily use a certain image processing algorithm as described above. Instead, a user who has visually checked an image can set a desired region of the image as the ROI.

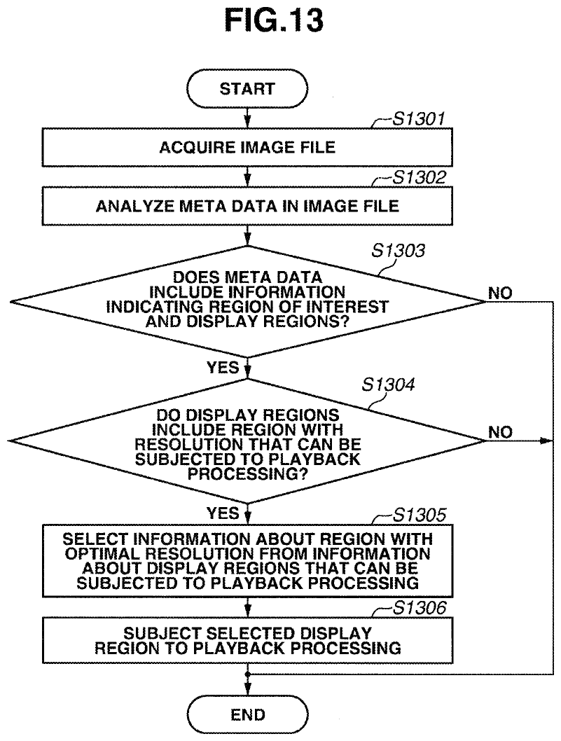

Processing for playing back a media file to which the region-of-interest information and the display region information are added according to the first to the fourth exemplary embodiments will be described next with reference to FIG. 13.

FIG. 13 is a flowchart illustrating processing for playing back a media file with the region of interest 203 and the display regions 205 to 207 added thereto by the media file generation apparatus 100 according to any of the above-described exemplary embodiments. This playback processing is performed by a central processing unit (CPU) of a media file processing apparatus (a media file playback apparatus) such as a personal computer (PC) or a mobile computer.

In step S1301, the CPU (an acquisition unit) acquires an image file (a media file).

In step S1302, the CPU (an analysis unit) analyzes meta data in the image file.

In step S1303, the CPU (an identification unit) identifies information indicating the region of interest 203 and the display regions 205 to 207 in the meta data. If the meta data includes the information indicating the region of interest 203 and the display regions 205 to 207 (YES in step S1303), the processing proceeds to step 51304. If the meta data does not include the information indicating the region of interest 203 and the display regions 205 to 207 (NO in step S1303), the processing exits the flowchart.

In step S1304, the CPU determines whether the display regions 205 to 207 include a display region with a resolution that can be subjected to the playback processing. If the display regions 205 to 207 include a display region with a resolution that can be subjected to the playback processing (YES in step S1304), the processing proceeds to step S1305.

If the display regions 205 to 207 do not include a display region with a resolution that can be subjected to the playback processing (NO in step S1304), the processing exits the flowchart.

In step S1305, the CPU selects information about the region with the optimal resolution from information about the display regions that can be subjected to the playback processing. As an example of the selection of the optimal resolution, the CPU selects a display region with the highest of the resolutions that can be subjected to the playback processing.

In step S1306, the CPU subjects the selected display region to the playback processing.

The file format according to the above-described exemplary embodiments is not limited to HEIF. AV1 Image File Format (AVIF) and other file formats are also applicable.

Each of the above-described exemplary embodiments can be implemented, for example, as a system, an apparatus, a method, a program, or a recording medium (a storage medium). More specifically, the above-described exemplary embodiments are applicable to a system including a plurality of devices (e.g., a host computer, an interface device, an imaging apparatus, and a web application) and to an apparatus including one device.

The above-described exemplary embodiments can also be implemented by supplying a program of software for implementing the functions according to the above-described exemplary embodiments directly or remotely to a system or an apparatus, and causing at least one computer of the system or the apparatus to read and executes the supplied program code. The program in this case is a computer-readable program corresponding to the illustrated flowcharts according to the exemplary embodiments.

Thus, in order for the computer to implement the functions and processing according to the exemplary embodiments, the program code itself installed on the computer also implements the exemplary embodiments. This means that the exemplary embodiments also include the computer program itself for implementing the functions and processing according to the exemplary embodiments.

In this case, the computer program can be an object code, an interpreter-executable program, or script data supplied to an operating system (OS) as long as a program function is provided thereto.

Examples of recording media for supplying the program include a floppy® disk, a hard disk, an optical disk, a magneto-optical disk (MO), a compact disc read only memory (CD-ROM), a compact disc recordable (CD-R), a compact disk rewritable (CD-RW), a magnetic tape, a nonvolatile memory card, a read only memory (ROM), and digital versatile discs (DVDs) (a digital versatile disc read only memory (DVD-ROM) and a digital versatile disc recordable (DVD-R)).

The program can also be supplied with the following method. A browser of a client computer connects to a home page on the Internet and then downloads the computer program itself (or a compressed file including an automatic installation function) according to the exemplary embodiments to a recording medium such as a hard disk. The program according to the exemplary embodiments can also be supplied by dividing the program code of the program into a plurality of files and downloading the files from different home pages. In other words, the exemplary embodiments also include a World Wide Web (WWW) server enabling a plurality of users to download the program files for implementing the functions and processing according to the exemplary embodiments on a computer.

It is also possible to deliver an encrypted version of the program according to the exemplary embodiments stored in a storage medium such as a CD-ROM, and enable a user satisfying a predetermined condition to download key information for solving the encryption from a home page via the Internet. In other words, the user can use the key information to execute the encrypted program and install the program on the computer.

The functions according to the above-described exemplary embodiments can also be implemented by the computer executing the read program. Further, the OS operating on the computer can perform a part or whole of actual processing based on the instructions of the program, and the functions according to the above-described exemplary embodiments can also be implemented through the processing.

The functions according to the above-described exemplary embodiments can also be implemented when the program read from a storage medium is loaded into a memory included in a function expansion board inserted into the computer or a function expansion unit connected to the computer, and then executed. In other words, a CPU included in the function expansion board or the function expansion unit can execute a part or whole of actual processing based on the instructions of the program.

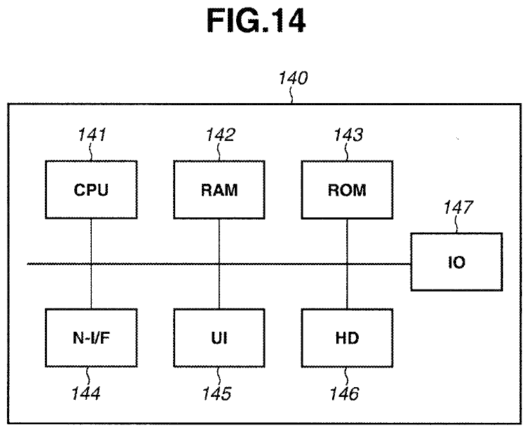

FIG. 14 is a schematic block diagram illustrating an information processing apparatus 140 for implementing at least one exemplary embodiment of the present disclosure. The information processing apparatus 140 can function as the media file generation apparatus 100 or the media file processing apparatus (the media file playback apparatus) according to any of the above-described exemplary embodiments.

The information processing apparatus 140 can be a microcomputer, a workstation, or a lightweight portable apparatus. The information processing apparatus 140 includes a communication bus connected to the following components.

A CPU 141 is a micro processing unit, for example. A random access memory (RAM) 142 stores resisters configured to record the codes for executing the methods according to the above-described exemplary embodiments and the variables and parameters for implementing the methods. The memory capacity of the RAM 142 can be expanded, for example, by using an optional RAM connected to an expansion port.

A read only memory (ROM) 143 stores computer programs for implementing the above-described exemplary embodiments.

A network interface (N-I/F) 144 is typically connected to a communication network through which processing target digital data is communicated. The network interface 144 can be a single network interface or can include a pair of different network interfaces (e.g., wired and wireless interfaces or different types of wired or wireless interfaces). A data packet is written to the network interface 144 for transmission or read therefrom for reception under the control of a software application executed by the CPU 141.

A user interface (UI) 145 is used to receive an input from the user and display information to the user.

A hard disk (HD) 146 is a storage device for storing media files, such as still image files and moving image files, and other various types of data.

An input/output module (I/O) 147 is used to exchange data with an external apparatus such as a video source or a display.

Executable codes can be stored in the ROM 143, the hard disk 146, or a removable digital medium such as a disk. After reception of the executable codes from a server through the communication network via the network interface 144, the executable codes can be stored in at least one of the storage devices of the information processing apparatus 140, such as the hard disk 146.

The CPU 141 is configured to control and order the execution of a part of program commands or software codes according to the above-described exemplary embodiments that are stored in at least one of the above-described storage devices. After power-on, the CPU 141 can load the commands related to a software application stored in the ROM 143 or the hard disk (HD) 146 into the RAM 142 and then execute the commands. When such a software application is executed by the CPU 141, each step of the flowcharts according to the above-described exemplary embodiments is implemented.

For any step according to the above-described exemplary embodiments, the commands or programs can be executed by a computer, such as a PC, a digital signal processor (DSP), or a micro controller. The exemplary embodiments can also be implemented by using a dedicated hardware component such as a Field-Programmable Gate Array (FPGA) or an Application-Specific Integrated Circuit (ASIC). Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The above-described exemplary embodiments make it possible to generate and process a media file that enables presenting an image including a region of interest while suppressing an increase in image data size.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-042910, filed Mar. 17, 2022, which is hereby incorporated by reference herein in its entirety.

What is claimed is:

1. A method for generating a media file, the method comprising:
acquiring image data;
generating first information indicating a region of interest that is at least a part of spatial regions in the image data;
generating second information indicating a plurality of different display regions each including the region of interest;
generating third information associating the first information with the second information; and
storing the first information, the second information, and the third information in meta data of the media file.

2. The method according to claim 1, wherein the third information includes information about spatial offsets of the region of interest with respect to the plurality of different display regions.

3. The method according to claim 2, wherein the third information is RegionItem.

4. The method according to claim 1, further comprising grouping the plurality of different display regions and generating group information including item information corresponding to a representative display region among the plurality of different display regions,
wherein the third information includes information indicating a spatial position of the region of interest in each of the plurality of different display regions as an offset value with respect to a coordinate origin of the representative display region.

5. The method according to claim 1, wherein the second information indicates that the plurality of different display regions is display candidates.

6. The method according to claim 1,
wherein the media file is a media file conforming to International Organization for Standardization (ISO)/International Electrotechnical Commission (IEC) 23008-12 (Image File Format), and
wherein the image data is a grid image.

7. The method according to claim 1,
wherein the media file is a moving image file where the image data includes a plurality of sub images, and
wherein the media file further includes:
a plurality of sub picture tracks corresponding to the plurality of sub images,
a plurality of different composite tracks corresponding to the plurality of different display regions, the plurality of different composite tracks each including at least one sub picture track selected from among the plurality of sub picture tracks, and
an extractor track for extracting one or more samples from the plurality of sub picture tracks or the plurality of different composite tracks.

8. The method according to claim 7, wherein the media file is a media file conforming to International Organization for Standardization (ISO)/International Electrotechnical Commission (IEC) 23090-2 (Omnidirectional MediA Format (OMAF)) or ISO/IEC 14496-15 (Carriage of network abstraction layer (NAL) unit structured video in ISO base media file format (ISOBMFF)).

9. The method according to claim 1, further comprising:
generating annotation information about the region of interest; and
generating fourth information associating the annotation information with the first information.

10. A method for processing a media file, the method comprising:
acquiring the media file;
analyzing meta data of the media file;
identifying first information stored in the meta data, the first information indicating a region of interest that is at least a part of spatial regions in image data stored in the media file;
identifying second information stored in the meta data, the second information indicating a plurality of different display regions each including the region of interest; and
identifying third information stored in the meta data, the third information associating the first information with the second information.

11. The method according to claim 10, wherein the third information includes information about spatial offsets of the region of interest with respect to the plurality of different display regions.

12. The method according to claim 11, wherein the third information is RegionItem.

13. The method according to claim 10, further comprising grouping the plurality of different display regions and identifying group information including item information corresponding to a representative display region among the plurality of different display regions,
wherein the third information includes information indicating a spatial position of the region of interest in each of the plurality of different display regions as an offset value with respect to a coordinate origin of the representative display region.

14. The method according to claim 10, wherein the second information indicates that the plurality of different display regions is display candidates.

15. The method according to claim 10,
wherein the media file is a media file conforming to International Organization for Standardization (ISO)/International Electrotechnical Commission (IEC) 23008-12 (Image File Format), and
wherein the image data is a grid image.

16. The method according to claim 10,
wherein the media file is a moving image file where the image data includes a plurality of sub images, and
wherein the media file further includes:
a plurality of sub picture tracks corresponding to the plurality of sub images,
a plurality of different composite tracks corresponding to the plurality of different display regions, the plurality of different composite tracks each including at least one sub picture track selected from among the plurality of sub picture tracks, and
an extractor track for extracting one or more samples from the plurality of sub picture tracks or the plurality of different composite tracks.

17. An apparatus comprising:
a memory storing a program; and
a processor that, when executing the program, causes the apparatus to:
acquire image data;
generate first information indicating a region of interest that is at least a part of spatial regions in the image data;
generate second information indicating a plurality of different display regions each including the region of interest;
generate third information associating the first information with the second information; and
store the first information, the second information, and the third information in meta data of the media file.

18. The apparatus according to claim 17, wherein the third information includes information about spatial offsets of the region of interest with respect to the plurality of different display regions.

19. An apparatus comprising:
a memory; and
a processor that, when executing the program, causes the apparatus to:
acquire the media file;
analyze meta data of the media file;
identify first information stored in the meta data, the first information indicating a region of interest that is at least a part of spatial regions in image data stored in the media file;
identify second information stored in the meta data, the second information indicating a plurality of different display regions each including the region of interest;
and identify third information stored in the meta data, the third information associating the first information with the second information.

20. The apparatus according to claim 19, wherein the third information includes information about spatial offsets of the region of interest with respect to the plurality of different display regions.
